(19) United States
(12) Patent Application Publication
(10) Pub. No.: US 2019/0047169 A1
(43) Pub. Date: Feb. 14, 2019

(54) LABOR-SAVING HOLE PUNCH

(71) Applicant: SDI CORPORATION, Chang Hua (TW)

(72) Inventor: Chi-Cheng HUNG, CHANG HUA (TW)

(21) Appl. No.: 16/056,230

(22) Filed: Aug. 6, 2018

(30) Foreign Application Priority Data
Aug. 10, 2017 (TW) 106127150

(51) Int. Cl. B26F 1/36

(52) U.S. Cl. CPC B26F 1/36; B26F 1/14

(57) ABSTRACT

A labor-saving hole punch includes a base, an operating unit, a linking unit, and a punching unit. The operating unit is pivotally mounted to the base for rotation relative to the base. The linking unit has two ends, one of which is connected to the operating unit and the other is pivotally mounted to the base. The punching unit is mounted to the base and connected to the linking unit. The operating unit and the linking unit are pivotally mounted to the same side of the base. The punching unit is connected to a midsection of the linking unit. The linking unit is actuated by the operating unit to drive the punching unit to punch. With the cooperation among the operating unit, the linking unit, and the punching unit, the hole punch has a long punch stroke to punch a larger number of paper sheets and to be labor-saving.

This application claims the benefit of Taiwan patent application No. 106127150, filed on Aug. 10, 2017, the entire contents of which are incorporated herein by reference.

### BACKGROUND OF THE INVENTION

### 1. Field of the Invention

The present invention relates to a hole punch, and particularly to a labor-saving hole punch.

### 2. Description of Related Art

Conventional hole punches are mainly used to form holes running through sheets of paper for bookbinding and collecting the sheets in a binder or folder. However, the punch strokes of the conventional hole punches are limited, so most of the conventional hole punches on the market were improved in mechanism for the labor-saving purpose.

CN Patent Publication No. 102101304 discloses a structure of a hole punch. The hole punch has a first lever, a second lever, a punching unit, and a frame. The first lever and the second lever are connected to each other to press the punching unit to punch. The fulcrums of the first lever and the second lever are pivotally positioned on the frame. A resistance point of the first lever is connected to the second lever, and a resistance point of the second lever is connected to the punching unit to save the effort for punching.

CN Patent No. 201082600 discloses a hole punching-riveting apparatus including a frame, a pressing lever, a sub-lever, a riveting mechanism, and a punching mechanism. The hole punching-riveting apparatus is actuated to rivet by pressing the pressing lever to move the riveting mechanism, and is actuated to punch by pressing the sub-lever to move a punching mechanism, making the apparatus a practical, dual-functional model. The fulcrums of the pressing lever and the sub-lever are pivotally positioned on the frame. The resistance point of the pressing lever is connected to the riveting mechanism. The effort point of the sub-lever is connected to the riveting mechanism. The resistance point of the sub-lever is connected to the punching mechanism. When the pressing lever is pressed, the riveting mechanism and the punching mechanism can be actuated at the same time.

US Patent Publication No. 2010/0058912 discloses a paper punch including a base, a main arm, two assistance arms, and two punch heads. The paper punch is actuated to punch mainly by pressing the main arm to move the assistance arms and the punch heads together. The fulcrums of the main arm and the assistance arms are pivotally positioned on a frame of the base. The resistance point of the main arm is slidably connected to the effort points of the assistance arms. The resistance points of the assistance arms are connected to the punch heads. When the main arm is actuated, the punch heads are driven to punch by the assistance arms.

CN Patent Publication No. 101121270 discloses a hole punch including a base, an upper cover, a connecting unit, and a punching unit. The hole punch is actuated to punch by pressing the upper cover to move the connecting unit and the punching unit. The fulcrums of the upper cover and the connecting unit are pivotally positioned on a frame of the base. The first resistance point of the upper cover is connected to the second effort point of the connecting unit. The second resistance point of the connecting unit is connected to the punching unit. When the upper cover is moved, the punching unit is actuated by the connecting unit to punch.

As seen from the aforesaid conventional punching devices, the layouts and configurations of the fulcrums, the resistance points or the effort points of the levers are limited by the interior structures of the respective punching devices, leading to various configurations of the levers.

Taking CN102101304 and CN201082600 for examples, the fulcrums of the levers are located oppositely, and the resistance points and the effort points are disposed between the two fulcrums.

Taking US2010/0058912 and CN101121270 for examples, the resistance point and the effort point of each of the levers are located at two opposite sides of the fulcrum of the corresponding lever, respectively.

Therefore, the conventional hole punches have short punch strokes because of the limitations on the aforementioned configurations of the levers. Therefore, the conventional hole punches cannot punch a large number of paper sheets due to the short punch strokes. Besides, the labor-saving effect is insufficient and the user needs to increase the strength of force applied by the hands or body weight to complete the punching process, so the user's hands may bend excessively with an incorrect and uncomfortable posture, to further negatively affect how the user feels while operating the conventional hole punches.

### SUMMARY OF THE INVENTION

To solve the problems that the configurations of the fulcrums, the resistance points or the effort points of the levers of the conventional hole punches cause short punch strokes and are not effectively labor-saving, the present invention provides a labor-saving hole punch, in which an operating unit can work with a linking unit, by means of adjustment of positions of levers, to generate a longer punch stroke for the labor-saving effect and for punching a large number of paper sheets.

The labor-saving hole punch includes a base, an operating unit, a linking unit, and at least one punching unit. The operating unit is pivotally mounted to the base and is capable of rotation relative to the base. The operating unit has a first pivot portion connected to the base, a first effort portion located distantly from the first pivot portion, and a first resistance portion located between the first pivot portion and the first effort portion. The linking unit is connected to the base and the operating unit and has a second pivot portion connected to the base, a second effort portion located distantly from the second pivot portion and connected to the first resistance portion of the operating unit, and a second resistance portion located between the second pivot portion and the second effort portion. The first pivot portion and the second pivot portion are located at the same side relative to the first resistance portion. The at least one punching unit is mounted to the base and is connected to the second resistance portion of the linking unit and can be moved up and down by the operating unit relative to the base.

### BRIEF DESCRIPTION OF THE DRAWINGS

FIG. 1 is a perspective view of a first embodiment of a hole punch in accordance with the present invention;

FIG. 2 is a perspective view showing a part of the hole punch;

FIG. 3 is an exploded view of the hole punch;

FIG. 3A is an enlarged perspective view of a part of the hole punch indicated in FIG. 3;

FIG. 4 is an enlarged exploded view of a part of the hole punch;

FIG. 5 is a side view of a linking bar of the hole punch;

FIG. 6 is another side view of the linking bar of the hole punch;

FIG. 7 is a diagram showing simplified leverage of the first embodiment of the hole punch;

FIG. 8 is a side view of the hole punch in operation;

FIG. 8A is an enlarged side view of a part of the hole punch indicated in FIG. 8;

FIG. 9 is another side view of the hole punch in operation;

FIG. 9A is an enlarged side view of a part of the hole punch indicated in FIG. 9;

FIG. 10 is a diagram showing simplified leverage of a second embodiment of the hole punch; and

FIG. 11 is a diagram showing simplified leverage of a third embodiment of the hole punch.

### DETAILED DESCRIPTION OF PREFERRED EMBODIMENT

First of all, directional references, such as “outer”, “inner”, “external”, “internal”, “outward”, “inward”, “downward”, “upward”, “top”, “bottom”, “uppermost”, “lowermost”, “anterior”, and the like, are only used based on conventional orientation of the drawings for identification purposes to facilitate the reader to understand the present invention by reference to the drawings and do not limit the associated elements, particularly as to the position, orientation, or use of this disclosure. Also, a person skilled in the art should notice this description may contain other terminology to convey position, orientation, and direction without departing from the principles of the present invention.

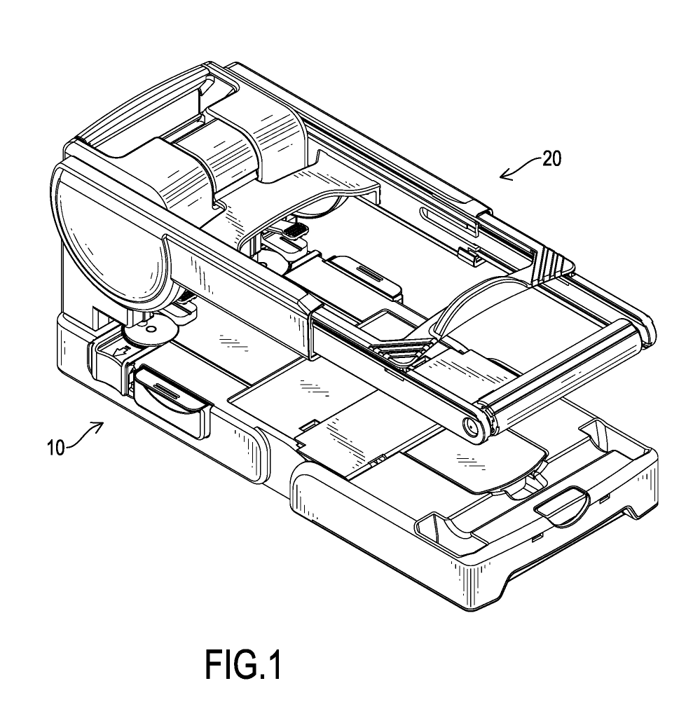

With reference to FIGS. 1 to 4, a labor-saving hole punch constructed in accordance with a first preferred embodiment of the present invention includes a base 10, an operating unit 20, a linking unit 30, and at least one punching unit 40.

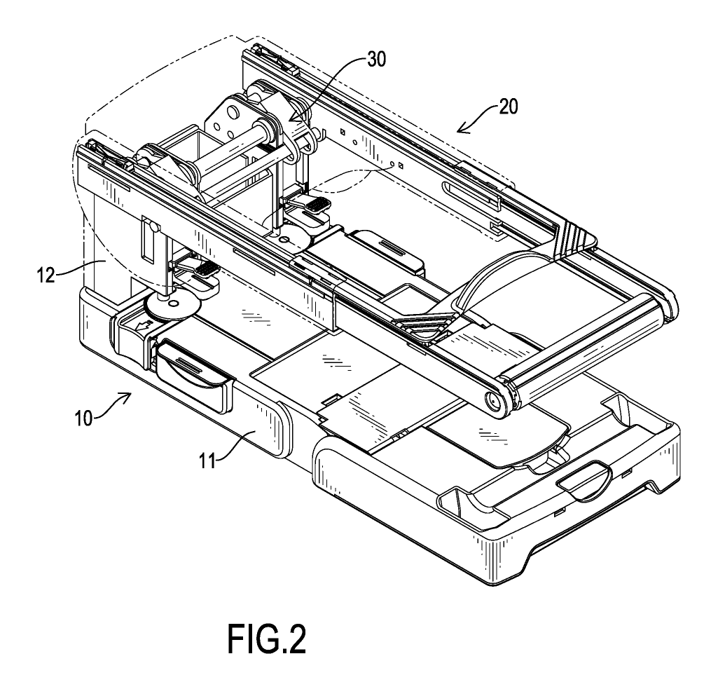

As shown in FIGS. 1 and 2, the base 10 has a body 11 and two racks 12 vertically mounted to the body 11. Preferably, in the first embodiment, the body 11 is foldable vertically and telescopic lengthwise. The racks 12 are parallel to each other and are mounted to one side of the body 11 at an interval formed therebetween. Each of the racks 12 has a pivot member 121 mounted to an outer side of the corresponding rack 12. An assembling space 122 is formed within each of the two racks 12 for assembling the linking unit 30 and the at least one punching unit 40.

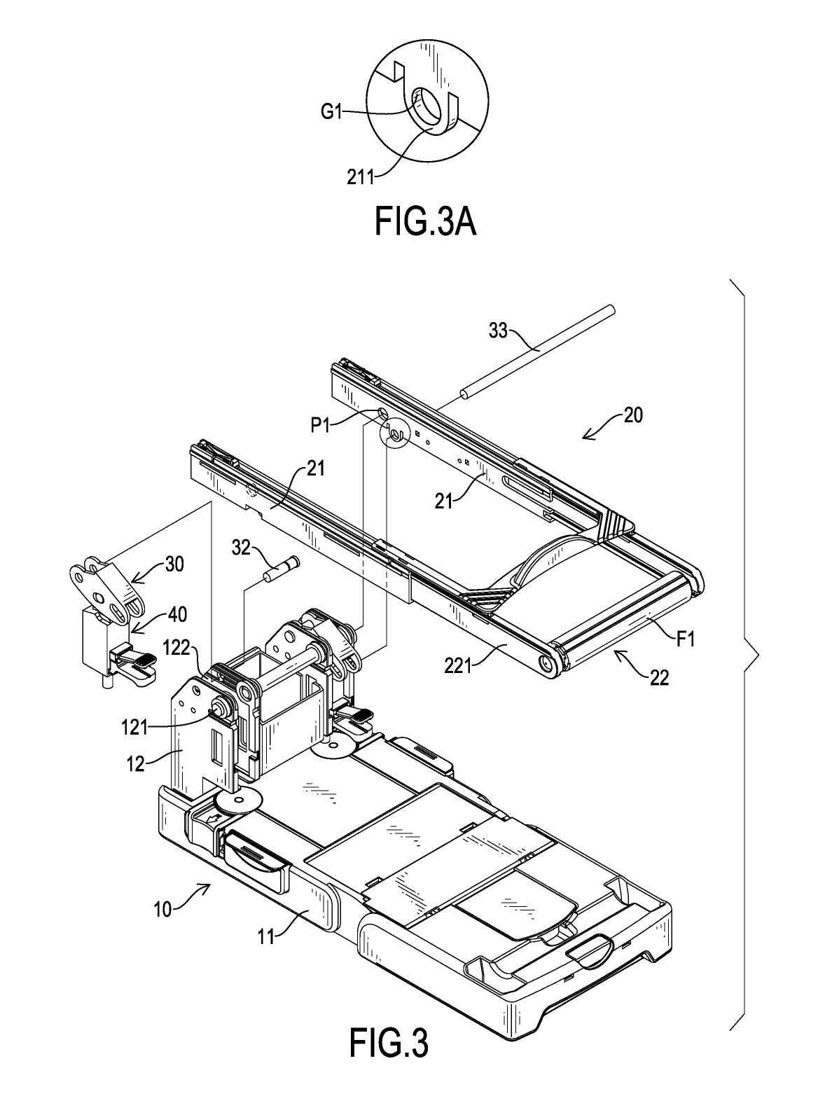

Referring to FIGS. 2, 3, and 3A, the operating unit 20 is pivotally mounted to the racks 12 for rotation relative to the base 10. Preferably, the length of the operating unit 20 can be adjusted telescopically relative to the racks 12. The operating unit 20 has two arms 21 and a telescopic handle 22 connected to the arms 21. The operating unit 20 includes a first pivot portion P1 connected to the base 10, a first effort portion F1 located distantly from the first pivot portion P1, and a first resistance portion G1 located between the first pivot portion P1 and the first effort portion F1.

In the first embodiment of the present invention, the arms 21 of the operating unit 20 are connected to the outer sides of the racks 12, respectively. Each arm 21 has a round hole formed at an inner side thereof, the two round holes serving as the first pivot portion P1. The shape of the first pivot portion P1 corresponds to that of the pivot member 121 of each rack 12. Each arm 21 has an acting portion 211 protruding downwardly from a bottom thereof. Each acting portion 211 has a round hole formed therein, the two round holes serving as the first resistance portion G1. The first pivot portion P1 of the arms 21 is pivotally disposed to the pivot member 121 of each rack 12. Therefore, the arms 21 are capable of rotation relative to the racks 12.

The telescopic handle 22 is approximately U-shaped and is connected to a side of the arms 21 which is opposite to the other side of the arms 21 pivoted to the base 10. The telescopic handle 22 is selectively telescopic relative to the arms 21, so the length of the operating unit 20 is adjustable. The telescopic handle 22 includes two bars 221 telescopically connected to the two arms 21, respectively. The first effort portion F1 is defined at one end of the telescopic handle 22. Preferably, the first effort portion F1 is embodied as a cross bar connected to and between the bars 221.

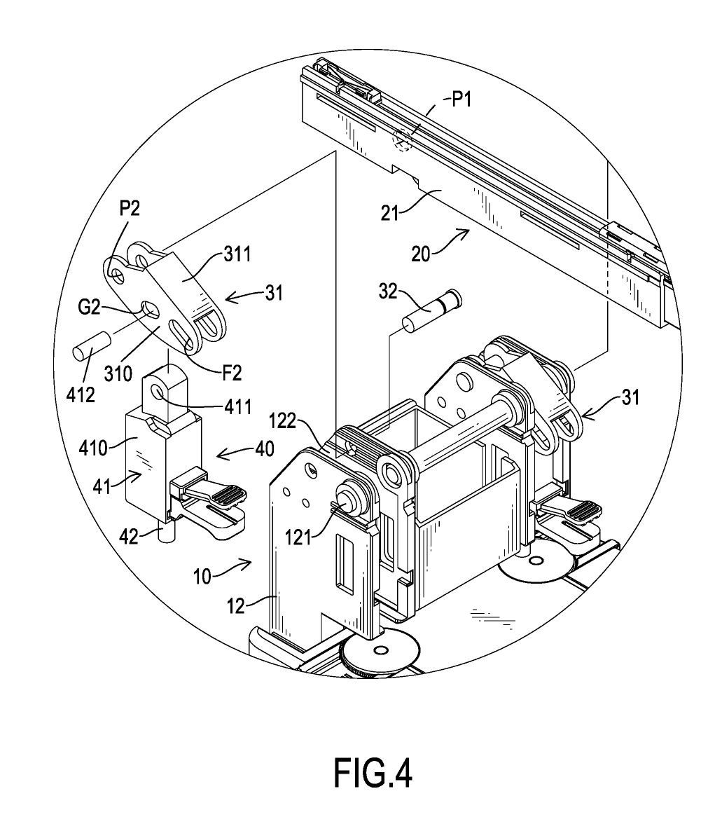

With reference to FIGS. 3 and 4, the linking unit 30 is rotatably mounted to the racks 12 of the base 10 and is mounted in the assembling space 122. The linking unit 30 includes a second pivot portion P2, a second effort portion F2, and a second resistance portion G2. The second pivot portion P2 is connected to the base 10. The second effort portion F2 is located distantly from the second pivot portion P2 and is connected to the first resistance portion G1 of the operating unit 20. The second resistance portion G2 is located between the second pivot portion P2 and the second effort portion F2. In addition, the first pivot portion P1 and the second pivot portion P2 are located at the same side relative to the first resistance portion G1.

The at least one punching unit 40 is mounted to the base 10 and is connected to the second resistance portion G2 of the linking unit 30. The at least one punching unit 40 can be actuated by the operating unit 20 to move upwardly and downwardly relative to the base 10.

Preferably, the linking unit 30 includes two linking bars 31 pivotally mounted to the racks 12 of the base 10, respectively. Each linking bar 31 is approximately U-shaped in a cross-sectional view and has two side plates 310, which have the same shape and are parallel to each other, and a connecting plate 311 connected between said two side plates 310. Each side plate 310 is elongated and has two through holes formed at two ends thereof, respectively. The two through holes of each side plate 310 serve as the second pivot portion P2 and the second effort portion F2, respectively. The second resistance portion G2 is located between the second pivot portion P2 and the second effort portion F2 at each side plate 310. A pivot rod 32 is inserted into the second pivot portion P2 of each side plate 310 for making each linking bar 31 mounted into the assembling space 122 of the corresponding rack 12. In this way, each linking bar 31 can be rotated on the second pivot portion P2 by the pivot rod 32 relative to the corresponding rack 12 by the pivot rod 32.

As shown in FIGS. 3 and 4, the operating unit 20 and the linking unit 30 are linked by an effort rod 33. The effort rod 33 is inserted through the first resistance portion G1 of the arms 21 and the second effort portion F2 of the side plates 310. Alternatively, the operating unit 20 and the linking bars 31 of the linking unit 30 can be linked by two said effort rods 33, each of which is inserted through the first resistance portion G1 of the corresponding arm 21 and the second effort portion F2 of the corresponding side plate 310. The number of the effort rod 33 and how the operating unit 20 and the linking unit 30 are connected via the effort rod 33 are not limited in the present invention.

In addition, the first resistance portion G1 of the operating unit 20 and the second effort portion F2 of the linking unit 30 can be slidably connected with each other. One of the first resistance portion G1 of the operating unit 20 and the second effort portion F2 of the linking unit 30 can be an elongated slot, and the other can be a round hole for limiting the effort rod 33 and keeping the effort rod 33 moving within the elongated slot. In the first embodiment of the present invention, the second effort portion F2 is a slot, and the first resistance portion G1 is a round hole. The operating unit 20 can be rotated to drive the effort rod 33 to move within the second effort portion F2, further leading to linking-up rotation of the linking rod 31. The configurations of the second effort portion F2 and the first resistance portion G1 are interchangeable and are not limited to those of the first embodiment of the present invention.

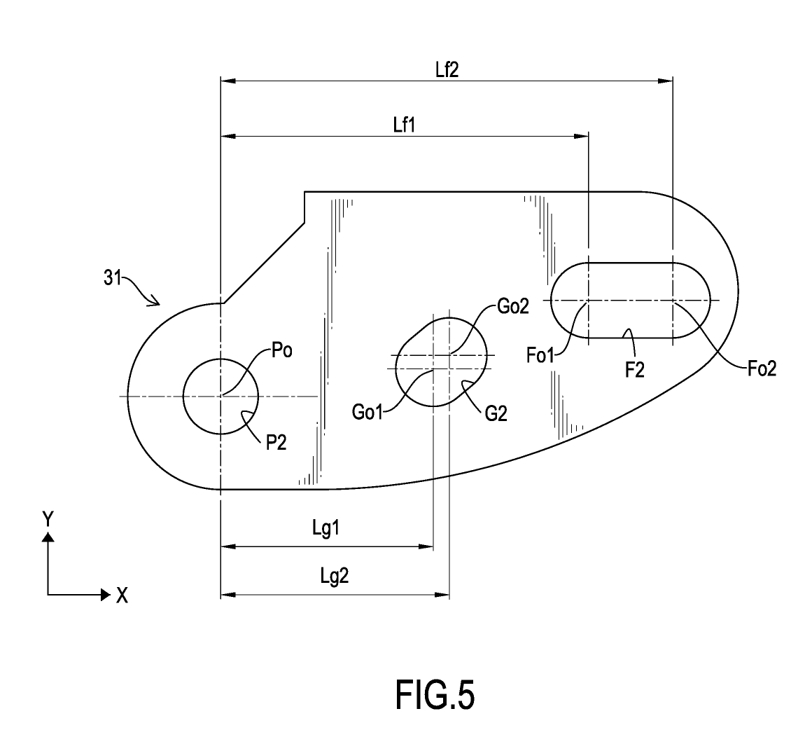

Referring to FIG. 5, an imaginary axis X is defined along a horizontal direction, and an imaginary axis Y is defined along a vertical direction and is perpendicular to the imaginary axis X. In the side plate 310 of each linking bar 31, a center of the second pivot portion P2, which is a round hole, is defined as Po, and the second effort portion F2 and the second resistance portion G2 are oblong slots. Each of the oblong slots has two arc-shaped ends. Centers of the two arc-shaped ends of the second effort portion F2 are defined as Fo1 and Fo2, respectively. Centers of the two arc-shaped ends of the second resistance portion G2 are defined as Go1 and Go2, respectively.

In the first embodiment, a first resistance lever arm Lg1 is defined by a distance between the center Po of the second pivot portion P2 and the center Go1 of the second resistance portion G2 along the imaginary axis X, and the length of the first resistance lever arm Lg1 ranges from 16 mm to 18 mm. A second resistance lever arm Lg2 is defined by a distance between the center Po of the second pivot portion P2 and the center Go2 of the second resistance portion G2 along the imaginary axis X, and the length of the first resistance lever arm Lg1 ranges from 18 mm to 20 mm. A first effort lever arm Lf1 is defined by a distance between the center Po of the second pivot portion P2 and the center Fo1 of the second effort portion F2 along the imaginary axis X, and the length of the first resistance lever arm Lg1 ranges from 28.5 mm to 30.5 mm. A second effort lever arm Lf2 is defined by a distance between the center Po of the second pivot portion P2 and the center Fo2 of the second effort portion F2 along the imaginary axis X, and the length of the first resistance lever arm Lg1 ranges from 35.5 mm to 37.5 mm.

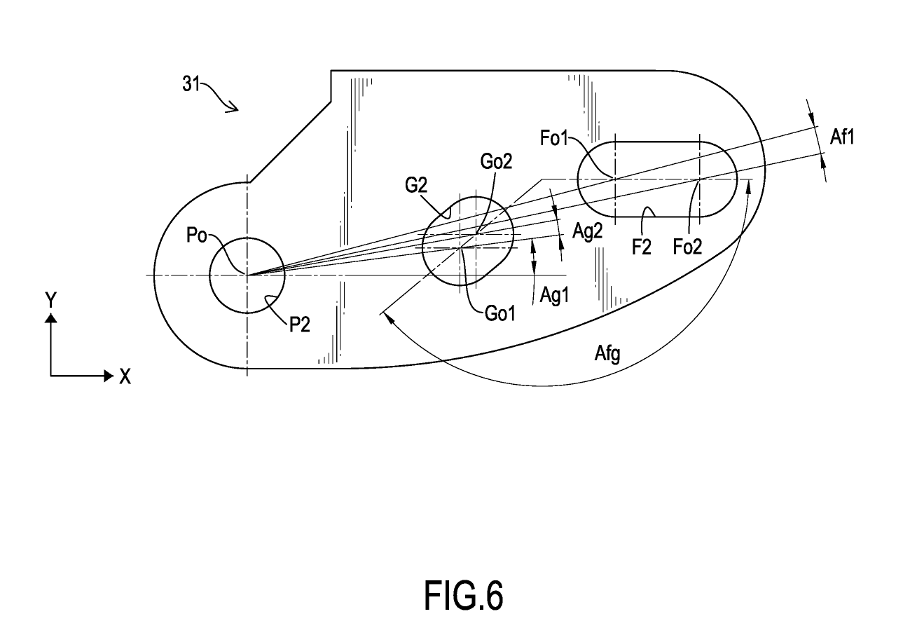

With reference to FIG. 6, an imaginary first long axis is defined between the centers Fo1 & Fo2 of the second effort portion F2, and an imaginary second long axis is defined between the centers Go1 & Go2 of the second resistance portion G2. An inclined angle Afg is defined between the imaginary first long axis and the imaginary second long axis and ranges from 138 degrees to 142 degrees.

A first resistance-slipping angle Ag1 is defined between an imaginary horizontal line and an imaginary straight line, the former of which is defined along the imaginary axis X and the latter is defined from the center Po of the second pivot portion P2 to the center Go1 of the second resistance portion G2. The first resistance-slipping angle Ag1 ranges from 5 degrees to 9 degrees.

A second resistance-slipping angle Ag2 is defined between an imaginary straight line and an imaginary straight line, the former of which is defined from the center Po of the second pivot portion P2 to the center Go1 of the second resistance portion G2 and the latter is defined from the center Po of the second pivot portion P2 to the center Go2 of the second resistance portion G2. The second resistance-slipping angle Ag2 ranges from 2 degrees to 6 degrees.

An effort-slipping angle Af1 is defined between an imaginary straight line and an imaginary straight line, the former of which is defined from the center Po of the second pivot portion P2 to the center Fo1 of the second effort portion F2 and the latter is defined from the center Po of the second pivot portion P2 to the center Fo2 of the second effort portion F2. The effort-slipping angle Af1 ranges from 1 degree to 5 degrees.

Referring to FIGS. 3 and 4, the hole punch of the present invention has two said punching units 40. The two punching units 40 are mounted to the racks 12 of the base 10, respectively, and are connected to the second resistance portion G2 of the linking unit 30; each punching unit 40 is pivotally mounted between the second pivot portion P2 and the second effort portion F2 of the corresponding linking unit 30. Preferably, each punching unit 40 is pivotally mounted between the side plates 310 of the corresponding linking bar 31, and is mounted in the assembling space 122 of the corresponding rack 12.

Each punching unit 40 has a holder 41 and a cutter 42. Each holder 41 has a rectangular holder body 410 and a connecting portion 411 formed at a top of the holder body 410. Each connecting portion 411 has a pivot hole. The pivot holes of the connecting portions 411 correspond to the second resistance portion G2 of the side plates 310 in location for a pivot shaft 412 to be inserted through each connecting portion 411 and each second resistance portion G2. In this way, the linking bars 31 are pivotally connected to the holders 41, respectively. When the linking unit 30 is moved, each linking bar 31 moves the corresponding holder 41 synchronously.

Preferably, each connecting portion 411 of the punching unit 40 and the corresponding second resistance portion G2 of the linking unit 30 are slidably connected with each other. One of the second resistance portion G2 of the linking unit 30 and the connecting portion 411 of the punching unit 40 can be a slot, and the other can be a round hole for confining the pivot shaft 412 thereto, such that the pivot shaft 412 can keep sliding within the slot relative to the round hole while the punching unit 40 is moved along with the linking unit 30. In the first embodiment of the present invention, each second resistance portion G2 of the linking unit 30 is a slot, and each connecting portion 411 of the punching unit 40 is a round hole. The configurations of the second resistance portion G2 and the connecting portion 411 are interchangeable and are not limited to those of the first embodiment of the present invention.

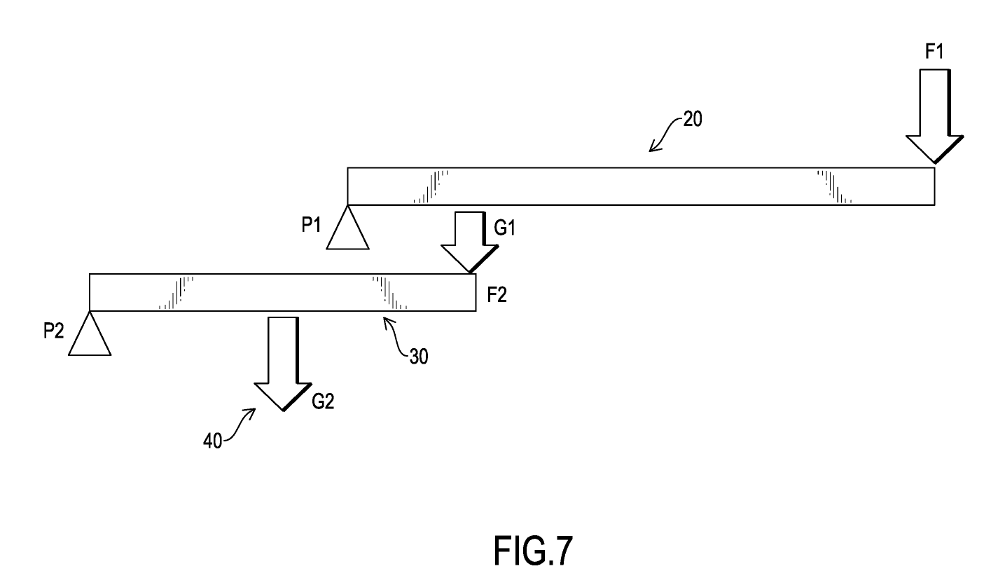

With reference to FIG. 7 and further in view of FIGS. 2 and 3, the structural interconnection relationships of the first embodiment of the present invention can be simplified in a schematic diagram in terms of leverage as shown in FIG. 7. The first effort portion F1 and the first pivot portion P1 are defined at two ends of the operating unit 20, respectively. The first resistance portion G1 is defined between the first effort portion F1 and the first pivot portion P1. The first pivot portion P1 of the operating unit 20 is connected to the base 10.

The second effort portion F2 and the second pivot portion P2 are defined at two ends of the linking unit 30, respectively. The second resistance portion G2 is defined between the second effort portion F2 and the second pivot portion P2. The first pivot portion P1 and the second pivot portion P2 are located at the same side relative to the first resistance portion G1. The second pivot portion P2 of the linking unit 30 is connected to the base 10, and the second effort portion F2 of the linking unit 30 is connected to the first resistance portion G1. In a word, the second resistance portion G2 of the linking unit 30 is located between the first resistance portion G1 and the second pivot portion P2. Each punching unit 40 is connected to the second resistance portion G2 of the linking unit 30 and is located between the first pivot portion P1 and the second pivot portion P2. In this way, a force applied to the first effort potion F1 can be transferred to the punching unit 40 connected to the second effort portion G2 for labor-saving punching.

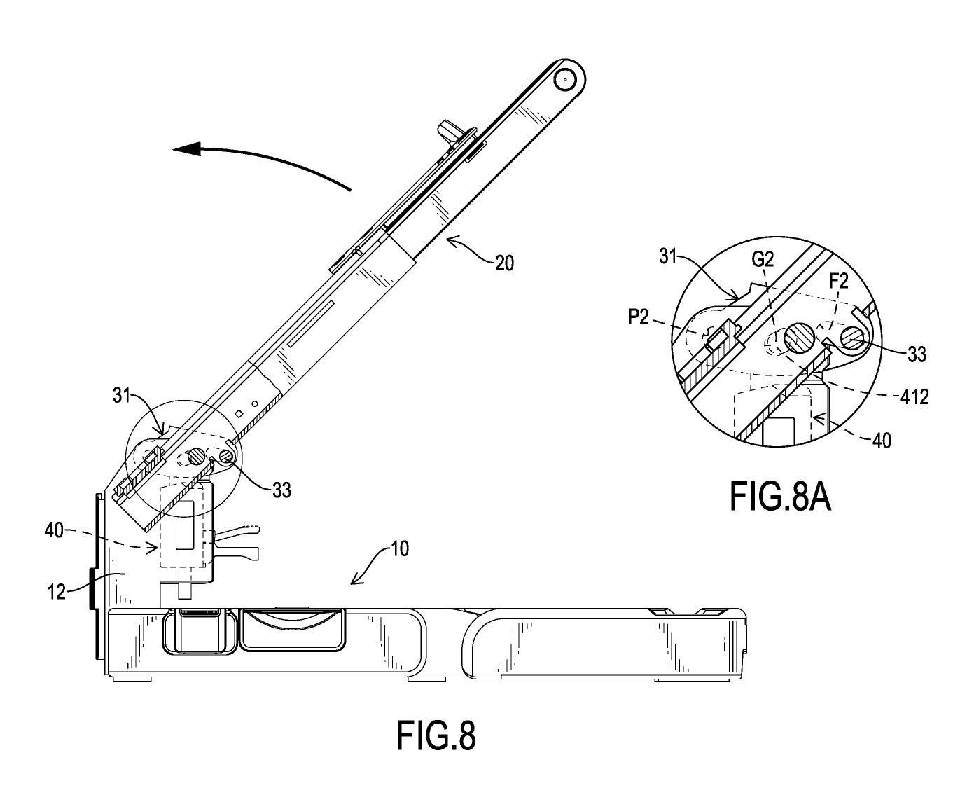

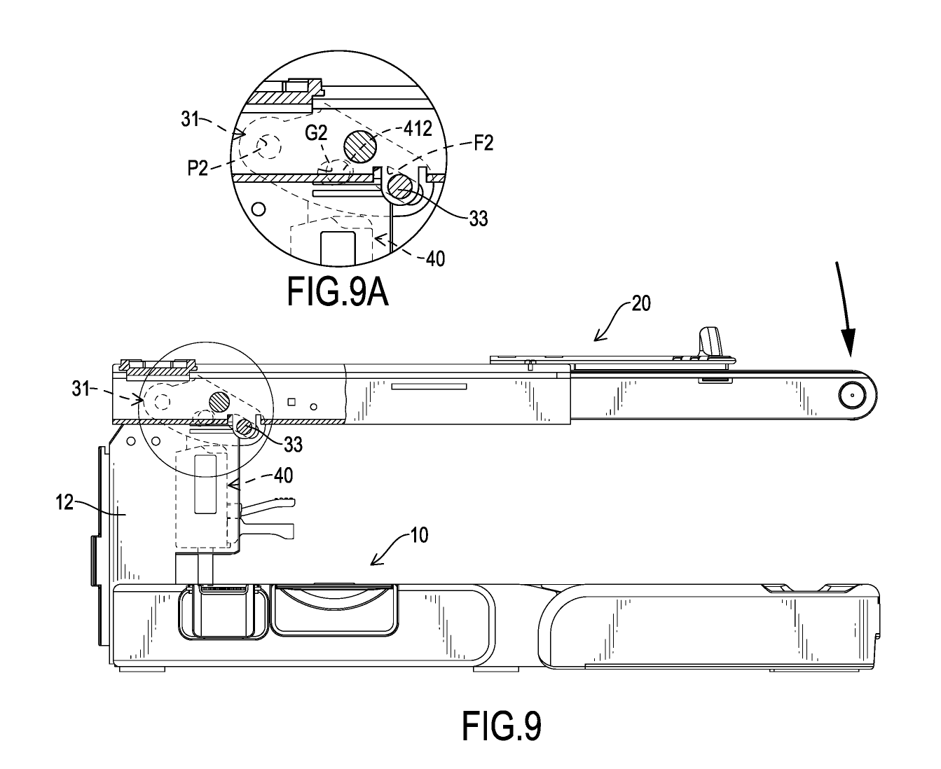

How the first embodiment of the present invention is operated is shown in FIGS. 8 and 8A. The operating unit 20 is capable of rotation relative to the base 10. When the operating unit 20 is raised upwardly for counterclockwise rotation, the linking bars 31 are moved by the effort rod 33 toward the same rotational direction relative to the operating unit 20 and the punching units 40 are also raised upwardly by the effort rod 33. Referring to FIGS. 9 and 9A, when the operating unit 20 is pressed downwardly for clockwise rotation, the effort rod 33 slides within the second effort portion F2 to move the linking bars 31. In the meantime, the pivot shaft 412 of each holder 41 slides within the second resistance portion G2, and then each cutter 42 is moved downwardly to punch holes.

In the first embodiment in view of FIG. 7, when an initial lever arm of the operating unit 20 remains in such a way that the operating unit 20 is not adjusted for more length, the length of the operating unit 20 is 190 mm, and a length from the first resistance portion G1 to the first pivot portion P1 is 10 mm. The force applied to the second effort portion F2 is equal to that applied to the first resistance portion G1. The ratio of a distance between the second effort portion F2 and the second pivot portion P2 to a distance between the second resistance portion G2 and the second pivot portion P2 is 2:1. Mechanical advantage of leverage of the present invention can be calculated by formulas as follows:

F1×19=G1×1→F1=G1/19 (1)

F2=G1→F1=F2/19 (2)

F2×2=G2×1→2F2=G2 (3)

G2/F1=2F2/(F2/19)→G2=38F1 (4)

According to the calculation result, the resistance in the second resistance portion G2 is 38 times the effort in the first effort portion F1, thus demonstrating an excellent labor-saving effect.

In the present invention, the resistance portion G1/G2 is located between the pivot portion P1/P2 and the effort portion F1/F2. The first pivot portion P1 of the operating unit 20 and the second pivot portion P2 of the linking unit 30 are located at the same side relative to the first resistance portion G1 of the operating unit 20. The second resistance G2 is located between the first resistance portion G1 and the second pivot portion P2. The punching unit 40 is pivotally connected between the second pivot portion P2 and the second effort portion F2 of the linking unit 30. In mechanics, the punching unit 40 may have a longer stroke to be capable of punching a larger number of paper sheets because the two fulcrums, i.e. P1 and P2, are located at the same side relative to the first resistance portion G1, and the second resistance portion G2 is located between the second effort portion F2, which is identical to the first resistance portion G1, of the linking bar 31 and the second pivot portion P2. The operating unit 20 has an excellent hole-punching effect without adjustment of the length of the initial lever arm. Furthermore, the slidable connection among the operating unit 20, the linking unit 30, and the punching unit 40 can increase the displacement of the punching unit 40 and the stroke of the punching unit 40 can be increased to 13 mm to punch much more paper sheets.

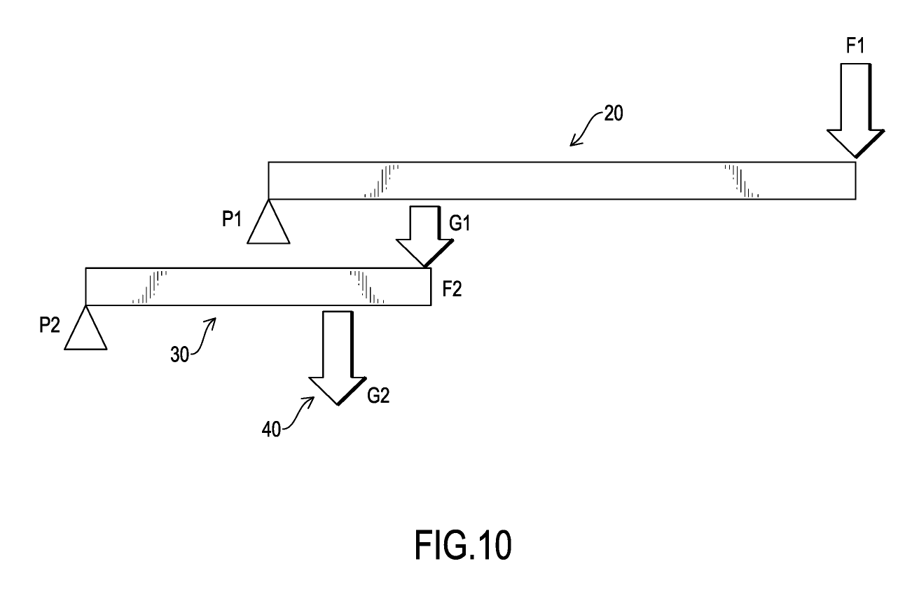

The structural interconnection relationships of a preferred second embodiment of the present invention can be simplified in a schematic diagram in terms of leverage as shown in FIG. 10. The configuration of the second embodiment is similar to that of the first embodiment of the present invention, the difference therebetween being the positions of the levers. Specifically, the at least one punching unit 40 in the second embodiment is located between the first pivot portion P1 of the operating unit 20 and the first resistance portion G1 of the operating unit 20.

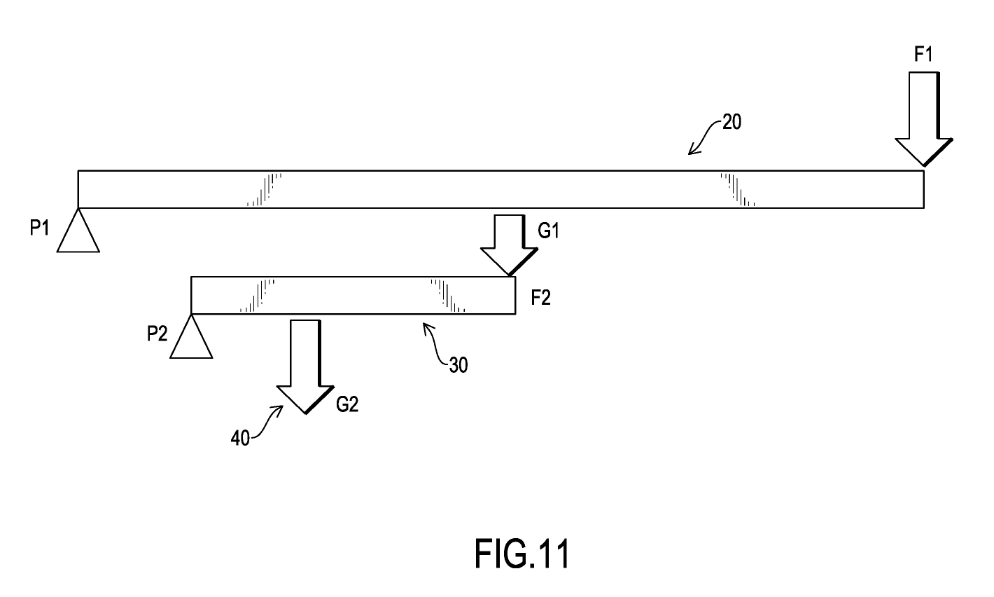

The structural interconnection relationships of a third preferred embodiment of the present invention is simplified in a schematic diagram in terms of leverage as shown in FIG. 11. The configuration of the third embodiment is similar to that of the first embodiment of the present invention, the difference therebetween being the positions of the levers. Specifically, the second pivot portion P2 of the linking unit 30 in the third embodiment is located between the first pivot portion P1 of the operating unit 20 and the second resistance portion G2 of the linking unit 30.

The present invention can be applied to a single-arm hole punch, in which one arm works with one linking bar and one punching unit. The present invention also can be applied to a multi-arm hole punch, in which multiple arms work with multiple linking bars and multiple punching units. Numbers of the arms of the operating unit 20, the linking unit 30, and the punching unit 40 are not limited in the present invention.

Even though numerous characteristics and advantages of the present invention have been set forth in the foregoing descriptions, together with details of the structure and function of the present invention, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A hole punch comprising:
a base;
an operating unit pivotally mounted to the base for rotation relative to the base, the operating unit having
a first pivot portion connected to the base;
a first effort portion located distantly from the first pivot portion; and
a first resistance portion located between the first pivot portion and the first effort portion;
a linking unit connected to the base and the operating unit and having
a second pivot portion connected to the base;
a second effort portion located distantly from the second pivot portion and connected to the first resistance portion of the operating unit; and
a second resistance portion located between the second pivot portion and the second effort portion;
wherein the first pivot portion and the second pivot portion are located at the same side relative to the first resistance portion; and
at least one punching unit mounted to the base and connected to the second resistance portion of the linking unit for upward and downward movement driven by the operating unit relative to the base.

2. The hole punch as claimed in claim 1, wherein the at least one punching unit is located between the first pivot portion and the second pivot portion.

3. The hole punch as claimed in claim 1, wherein the at least one punching unit is located between the first pivot portion and the first resistance portion.

4. The hole punch as claimed in claim 1, wherein the second pivot portion of the linking unit is located between the first pivot portion and the second resistance portion.

5. The hole punch as claimed in claim 1, wherein the linking unit includes two linking bars, the hole punch has two said punching units, the base has two racks, the linking bars are pivotally mounted to the racks, respectively, and the two punching units are connected to and correspond to the two linking bars, respectively.

6. The hole punch as claimed in claim 1, wherein the first resistance portion of the operating unit and the second effort portion of the linking unit are slidably connected with each other.

7. The hole punch as claimed in claim 6, wherein one of the first resistance portion of the operating unit and the second effort portion of the linking unit is an elongated slot.

8. The hole punch as claimed in claim 7, wherein an effort-slipping angle is defined between the second pivot portion and the second effort portion and ranges from 1 degree to 5 degrees.

9. The hole punch as claimed in claim 7, wherein a first effort lever arm is defined between the second pivot portion and the second effort portion, and the first effort lever arm is provided with a length ranging from 28.5 mm to 30.5 mm.

10. The hole punch as claimed in claim 7, wherein a second effort lever arm is defined between the second pivot portion and the second effort portion, and the second effort lever arm is provided with a length ranging from 35.5 mm to 37.5 mm.

11. The hole punch as claimed in claim 1, wherein the second resistance portion of the linking unit is slidably connected to a connecting portion of the at least one punching unit.

12. The hole punch as claimed in claim 11, wherein one of the second resistance portion of the linking unit and the connecting portion of the at least one punching unit is a slot.

13. The hole punch as claimed in claim 12, wherein a first resistance-slipping angle is defined between the second pivot portion and the second resistance portion and ranges from 5 degrees to 9 degrees.

14. The hole punch as claimed in claim 12, wherein a second resistance-slipping angle is defined between the second pivot portion and the second resistance portion and ranges from 2 degrees to 6 degrees.

15. The hole punch as claimed in claim 12, wherein a first resistance lever arm is defined between the second pivot portion and the second resistance portion, and the first resistance lever arm is provided with a length ranging from 16 mm to 18 mm.

16. The hole punch as claimed in claim 12, wherein a second resistance lever arm is defined between the second pivot portion and the second resistance portion, and the second resistance lever arm is provided with a length ranging from 18 mm to 20 mm.

17. The hole punch as claimed in claim 6, wherein the second resistance portion of the linking unit is slidably connected to a connecting portion of the at least one punching unit.

18. The hole punch as claimed in claim 17, wherein an inclined angle is defined between the second effort portion of the linking unit and the second resistance portion of the linking unit, and the inclined angle ranges from 138 degrees to 142 degrees.

19. The hole punch as claimed in claim 1, wherein the at least one punching unit includes a holder and a cutter connected to the holder.
